(19) United States
(12) Patent Application Publication
(10) Pub. No.: US 2017/0031587 A1
(43) Pub. Date: Feb. 2, 2017

(54) ELECTRONIC DEVICE AND CONTROL PROGRAM THEREFOR

(71) Applicant: SEIKO EPSON CORPORATION, TOKYO (JP)

(72) Inventors: Takeshi KIMOTO, Tokyo (JP); Susumu INOUE, Matsumoto (JP)

(21) Appl. No.: 15/151,817

(22) Filed: May 11, 2016

(30) Foreign Application Priority Data
Jul. 29, 2015 (JP) 2015-149348

(51) Int. Cl. G06F 3/0485; G06F 3/041; G06F 3/0488; G06F 3/0482; G06F 3/0484

(52) U.S. Cl. CPC G06F 3/04855; G06F 3/0482; G06F 3/04842; G06F 3/04845; G06F 3/04883; G06F 3/0412

(57) ABSTRACT

In response to an instruction tool pointing at a first object and pointing at a different position A in a state in which a display section displays the first object, a display controller causes a second object relating to the first object to be displayed in an object region which is a region having the position A as an end of the region.

### CROSS REFERENCES TO RELATED APPLICATIONS

The entire disclosure of Japanese Patent Application No. 2015-149348, filed Jul. 29, 2015 is incorporated by reference herein.

### BACKGROUND

1. Technical Field

The present invention relates to an electronic device and a control program therefor, and particularly, to a user interface.

2. Related Art

Recently, known is an electronic device in which a list of a plurality of items is displayed on a menu screen (for example, FIG. 7 in JP-A-2014-2756).

In the electronic device of the related art, when an item is selected in a state in which a plurality of items are displayed as a list, a plurality of detailed items corresponding to the selected item are further displayed as a list, for example, in a lower part of a screen below the selected item. However, a user is not allowed to adjust a degree of displaying of the detailed items which are displayed as a list, and for example, all the detailed items corresponding to a certain item are displayed as a list. Accordingly, there is a problem in that information which the user wants to check other than the detailed items on the screen is, for example, hidden under the displayed list of the detailed items and usability is not good.

### SUMMARY

An advantage of some aspects of the invention is that usability relating to an electronic device is improved.

According to an aspect of the invention, an electronic device includes a display controller that causes a display section to display an image, and a detecting section that detects movement of an instruction tool. In response to the instruction tool pointing at a first object and pointing at a different position A in a state in which the display section displays first object, the display controller causes a second object relating to the first object to be displayed in an object region which is a region having the position A as an end of the region.

When adopting the configuration described above, the user who operates an instruction tool can designate a range (position, size, shape, and the like) of the object region for displaying the second object. Therefore, the user can designate the object region by avoiding the location of other objects which the user desires to recognize along with the second object (the other objects are prevented from being hidden by the second object). In addition, since the user can designate a size of the object region, the user can adjust a degree of displaying of the second object at one time in the object region. Therefore, according to the invention, usability relating to display of information on the electronic device can be improved. The second object may be displayed in any form as long as the second object is displayed in the object region. For example, the second object may be displayed in the entire region of the object region, or the second object may be displayed in a part of the object region. Moreover, the instruction tool may point at a position different from an actual position in some cases, and the position pointed at by the instruction tool may be different from the position A.

Here, the first object is a display element which is displayed on a screen of the display section and is a subject receiving an operation by the instruction tool. The second object may be a display element as the subject receiving an operation by the instruction tool, or may be a display element which is not the subject. The second object displayed in the object region may be a single object or multiple objects.

In addition, the object region may be any region as long as the position A is determined as a part of boundaries of the region. For example, in a case in which the object region has a rectangular shape, the object region may be determined as a region in which the position A is set as an apex, or the object region may be determined as a region in which the position A is set as a part of the sides. A shape of the object region is not limited to a rectangular shape, and may be other various shapes such as a circle or an ellipse. The position A is applicable as long as the point A is different from a starting point defining the first object, and the position A may exist in the region defined as the first object, or the position A may exist outside the region.

In addition, various known pointing devices may be used as the instruction tool. In a case of touch panels, the pointing device may be fingers, touch pens, or the like. A mode in which the instruction tool points at the first object and subsequently points at the position A may be implemented by, for example, a pinch-in operation or a pinch-out operation using two fingers. In addition, for example, a dragging operation by one finger or a pointing device such as a mouse pointing at one position may be assumed. Further, various modes in which other input devices are combined, for example, can be adopted.

In the electronic device, the first object may indicate a content group, and the second object may indicate contents included in the content group. Here, a content group means the group in which one or more contents relating to each other are brought together into one group.

In the electronic device, the object region may be a region extending from a region indicating the first object before the second object is displayed to the position A.

In such a configuration, the user can designate the object region with at least one instruction tool. That is, the user can designate the object region by pointing at the first object with at least one instruction tool and thereafter pointing at another position A different from a position at which the first object is initially pointed.

In the electronic device, the object region may be a region extending from the position A pointed by a first instruction tool to a position B pointed by a second instruction tool.

In the configuration, the user can designate the object region as a region from the position A to the position B which are individually pointed at using two instruction tools. Therefore, the object region can be set regardless of a region displaying the first object before displaying the second object.

The position A and the position B may be located in a region indicating the first object, or one or both of the position A and the position B may be located outside the region indicating the first object. The object region may be a region from the position B pointed by the first instruction tool to the position A pointed by the second instruction tool.

In the electronic device, the display controller may cause a first scroll bar corresponding to the first object to be displayed outside the object region, and causes a second scroll bar corresponding to the second object to be displayed in the object region.

With the first scroll bar, the user can recognize positional relationships between the objects currently being displayed and all the objects that may be displayed in a list in the same rank as the first objects. The user can scroll the first objects with reference to the positional relationship indicated by the first scroll bar. In addition, with the second scroll bar, the user can recognize positional relationships between the second objects currently being displayed and all the objects that may be displayed in a list as the second objects. The user can scroll the second objects in the object region with reference to the positional relationship indicated by the second scroll bar.

In the electronic device, the display controller may cause a first scroll bar corresponding to the first object to be displayed outside an object region in rectangular shape along a first side of the object region, and may cause a second scroll bar corresponding to the second object to be displayed outside the object region along a second side opposite the first side of the object region.

In a case in which the second scroll bar is displayed outside the object region, when the second scroll bar is displayed at the first side where the first scroll bar is displayed and if the first scroll bar and the second scroll bar are overlapped with each other, for example, the two scroll bars may not be clearly identified. Therefore, when the respective first scroll bar and second scroll bar are provided apart from each other along two opposite sides of the object region as the configuration according to the aspect, each of the scroll bars can be easily identified.

In the electronic device, the display controller may cause displaying of the second scroll bar to be terminated, in a case in which a movement of the instruction tool is not detected for a period of time that is equal to or greater than a threshold after the second object is displayed in the object region.

When the displaying of the second scroll bar is terminated after the period of time that is equal to or greater than a threshold elapses, the user can recognize the display contents in a region which is hidden when the second scroll bar is displayed. In a case in which the period of time that is equal to or greater than a threshold elapses after an operation with respect to the second scroll bar is terminated, the displaying of the second scroll bar may be terminated.

In the electronic device, the display controller may cause a first scroll bar corresponding to the first object to be displayed outside the object region, and may cause another object which indicates that the second object currently not displayed exists to be displayed in at least an end portion in a scroll direction of the second object in the object region.

When the other object is provided, the user can recognize that the second object which is not currently displayed exists. In addition, the user can display the second object which is not currently displayed, by scrolling the second object with reference to the other object.

In the electronic device, the display controller may cause the first object to be displayed, even when the second object is displayed in the object region, and the display controller may cause displaying of the second object to be terminated by canceling the object region in response to the instruction tool again pointing at the first object.

In this case, the object region can be closed by pointing at the first object using the instruction tool in a state in which the second object is displayed.

In the electronic device, the display controller may cause the first object to be displayed, even when the second object is displayed in the object region, and may cause the object region to move to a region, in which a different position C is set as an end in response to the instruction tool pointing at the position C after pointing at the first object again during the second object being displayed in the object region.

In this case, the user can easily designate the object region again.

In the electronic device, in a state in which a plurality of second objects are displayed in the object region, the display controller may terminate displaying of the plurality of the second objects by canceling the object region in response to detecting a first operation of a user, and the display controller may cause the first object, in a case in which the second objects are not displayed but at least one of the second objects has been selected, to be displayed at a position different from a position in a case in which any one of the second objects has not been selected.

In this case, based on a display position of the first object corresponding to the second object after canceling the object region and not displaying the second object, the user can recognize easily whether the second object has been selected. The first operation may be any of various operations which include at least an instruction for not displaying the second object by canceling (closing) the object region. The first operation may be an operation instructing the selection of the second object and the cancellation of the object region and not displaying the second object at one time. In a case in which the first operation does not include the instruction for selecting the second object, a selecting operation and a selecting cancellation operation with respect to the second object are executed after the instruction operation for displaying the second object in the object region is performed and before the first operation is performed.

Another aspect of the invention is a control program of the electronic device for realizing the above described functions. Functions of the sections according the aspect are realized by a hardware resource in which functions thereof are specified by its configuration, a hardware resource in which functions thereof are specified by programs, or a combination thereof. In addition, the functions of sections are not limited to those realized with the hardware resource in which the functions are physically implemented independently from each other.

### BRIEF DESCRIPTION OF THE DRAWINGS

The invention will be described with reference to the accompanying drawings, wherein like numbers reference like elements.

FIG. 1 is a block diagram illustrating a configuration of a smartphone.

FIGS. 2A to 2F are schematic views illustrating display control according to a first embodiment.

FIGS. 3A to 3F are schematic views illustrating display control according to the first embodiment.

FIGS. 4A and 4B are schematic views illustrating display control according to the first embodiment.

FIGS. 5A to 5F are schematic views illustrating display control according to a second embodiment.

FIGS. 6A and 6B are schematic views illustrating display control according to a third embodiment.

FIGS. 7A to 7C are schematic views illustrating display control according to another embodiment.

FIGS. 8A to 8C are schematic views illustrating display control according to further another embodiment.

### DESCRIPTION OF EXEMPLARY EMBODIMENTS

Hereinafter, embodiments of the invention will be described with reference to the attached drawings. Elements common to the embodiments are given the same symbols, and overlapped description thereof will not be repeated.

### 1. First Embodiment

### 1-1. Configuration

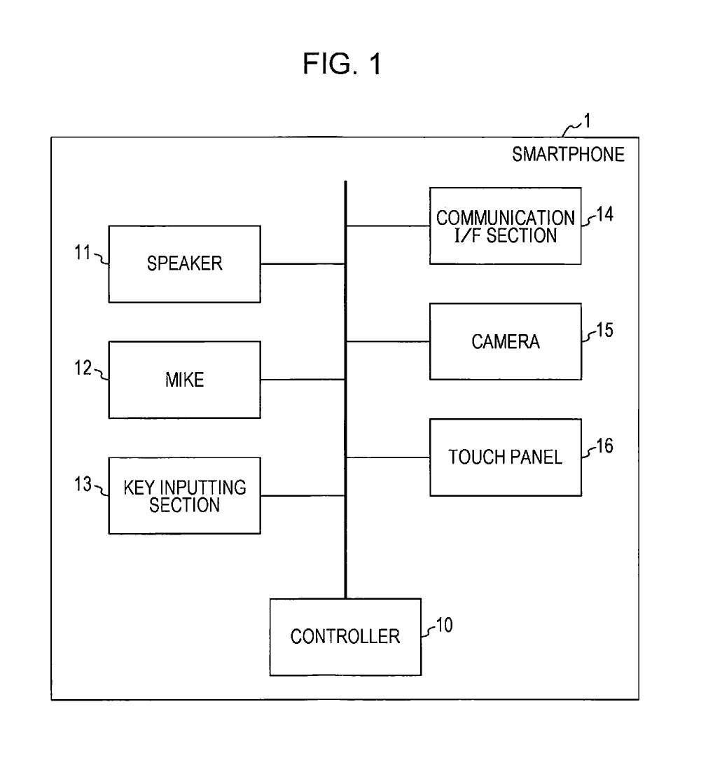

FIG. 1 is a block diagram illustrating a configuration of a smartphone 1 as an example of the electronic device of the invention. The smartphone 1 includes a controller 10, a speaker 11 which generates sounds, a microphone 12 which collects sounds, a key inputting section 13 that includes a power button and a home button, a communication I/F section 14, a camera 15, a touch panel 16, and the like. The touch panel detects a contact position of a finger, a touch pen, or the like, as an instruction tool by any of various known methods such as a capacitive sensing method or an infrared method. The touch panel 16 of the embodiment includes, for example, a display which displays images based on control of the controller 10, and a capacitance type touch-detecting panel on the display. In a case in which the instruction tool is a finger, a pinch-out is an operation of increasing the distance between two fingers in contact with a screen, and a pinch-in is an operation of decreasing the distance between two fingers in contact with the screen. Even in a case in which the instruction tool is a tool other than fingers, similar operations will be respectively referred to as the pinch-out and pinch-in operations.

The controller 10 may include a CPU, a RAM, a ROM, a non-volatile memory, and the like, and various programs stored in the ROM or the non-volatile memory can be executed by the CPU. A control program included in the various programs is used for realizing a function of detecting a motion of the instruction tool by obtaining from the touch panel 16 information (coordinates of contact position, or the like) indicating an operation on the touch panel 16, and a function of causing an image to be displayed on a screen of the touch panel 16. In the embodiment, the controller 10 corresponds to a “detecting section” and a “display controller”. The touch panel 16 corresponds to the “detecting section” and a “display section”.

The communication I/F section 14 includes a wireless communication interface for coupling to the Internet. In addition, the communication I/F section 14 includes an interface for performing voice-communication by connecting to a telephone network. The camera 15 includes lenses, area image sensors, and image processing circuits, and captures an image of an object to generate digital image data.

### 1-2. Display Control Relating to Operation:

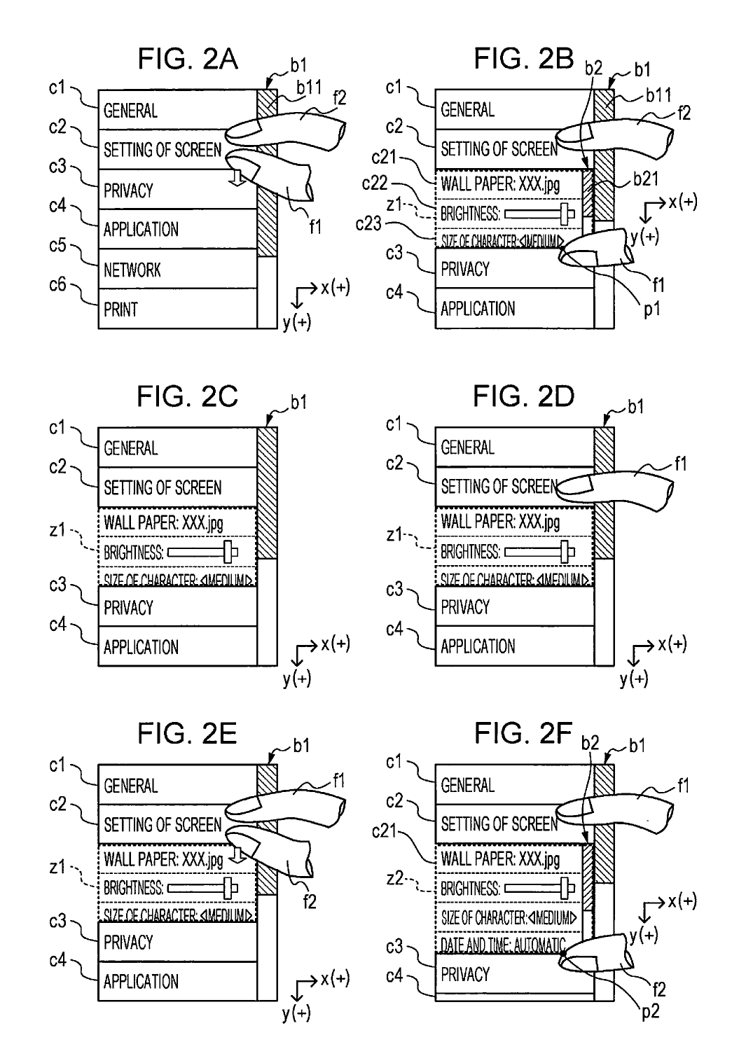

Next, an operation which is performed by a user when the smartphone 1 receives various settings, and display control performed by the controller 10 in response to the operation will be described. FIG. 2A illustrates a screen of the touch panel 16 on which objects c1 to c6 indicating a plurality of items of a first layer of a setting menu are displayed. Each of the objects c1 to c6 is rectangular in shape. The objects c1 to c6 are displayed side by side in the form of a list in the screen of the touch panel 16. For convenience of explanation, an x axis and a y axis orthogonal to each other are defined in a rectangular screen of the touch panel 16. The objects c1 to c6 are displayed side by side parallel to the y axis. A y-axis positive direction (hereinafter also referred to as +y direction) is defined as a downward direction in the screen and an x-axis positive direction (hereinafter also referred to as +x direction) is defined as a rightward direction in the screen, and hereinafter description will be given accordingly.

A first scroll bar b1 extending parallel to the y-axis is a scroll bar corresponding to items of the first layer. In a case in which the controller 10 detects that a slider (knob) b11 of the first scroll bar b1 is dragged in a direction parallel to the y-axis, the controller 10 scrolls a list of the items of the first layer in accordance with a moving amount of the slider b11, and allows the items of the first layer, which are not displayed before dragging, to be displayed. In addition, a ratio of a length of the slider b11 to a length of the entirety of the first scroll bar b1 in a direction parallel to the y-axis and a position of the slider b11 in the entirety of the first scroll bar b1 indicate a positional relationship of the items of the first layer, which are currently displayed, with the entirety of the items of the first layer, and the user can drag the slider b11 by taking into consideration of the positional relationship. In a case in which the controller 10 detects that the slider b11 is not dragged but a direct drag operation (operation at least including movement in the y direction) is performed on an object itself indicating the item of the first layer, the controller 10 may scroll the items of the first layer.

Items of a second layer are related to each of the plurality of items of the first layer. Each of the items of the first layer corresponds to a group (content group) that is the group constituted by one or more related items (contents) of the second layer. When an object indicating an item of the first layer is selected, an object indicating an item of the second layer is displayed. In a state in which the list of the items of the first layer is displayed as illustrated in FIG. 2A, for example, when the pinch-out operation on the object c2 (corresponding to first object) indicating “setting of a screen” is detected as described below, the controller 10 sets a rectangular object region z1 as illustrated in FIG. 2B, and causes objects (corresponding to second objects) indicating the items of the second layer, which are included in the item of “setting of a screen” indicated by the object c2 in the object region z1, to be displayed as a list as illustrated in FIG. 2B. Specifically, the pinch-out operation illustrated in FIG. 2A and FIG. 2B is an operation in which after two fingers are in contact with the object c2, one finger f2 among the two fingers remains in the region of the object c2 while being in contact with the screen, and the other finger f1 moves at least in the +y direction while being in contact with the screen (may move in a direction parallel to the x axis) and moves to a point p1 (corresponding to position A) outside the region of the object c2 as illustrated in FIG. 2B. When such a pinch-out operation is detected, the controller 10 sets the object region z1. The region z1 has an upper end in a direction parallel to the y axis, which is the lower end of the object c2 to be pinched out in the +y direction, and has a lower end in the direction parallel to the y axis including the point p1 pointed by the finger f1 moved from the lower end of the object c2. The controller 10 causes a plurality of objects indicating the items of the second layer to be displayed in the object region z1 as a list. The object region z1 is set to have the same length and position as the objects c1 to c6 in a direction parallel to the x axis. The point p1 determines the length of the object region z1 in a direction parallel to the y axis.

The controller 10 determines the number of objects indicating the items of the second layer (the number of items to be displayed) in accordance with the length of the object region z1 in the direction parallel to the y axis. In an example of FIG. 2B, objects c21 to c23 indicating three items of the second layer are displayed in the object region z1. The controller 10 causes the objects (objects C3 and thereafter) indicating the items of the first layer next to the object c2 on which a pinch-out operation is performed to be displayed in a region deviated in the +y direction from the point p1 as illustrated in FIG. 2B, however, alternatively the controller 10 may cause the object region z1 to be overlapped with the object c3 or the like and displayed.

As described above, according to the embodiment, a range (position, size, or the like) of an object region for displaying items of the second layer can be set by the user. Accordingly, even if the screen of the touch panel 16 of the smartphone 1 is not sufficiently wide, information can be displayed flexibly in accordance with a need of the user. Therefore, according to the embodiment, usability relating to displaying information in the electronic device can be improved.

In addition, in the object region z1, the controller 10 allows a second scroll bar b2 corresponding to items of the second layer to be displayed as illustrated in FIG. 2B. The second scroll bar b2 extends in a direction parallel to the y axis. When the controller 10 detects that the user drags a slider b21 of the second scroll bar b2 in a direction parallel to the y axis, the controller 10 scrolls the items of the second layer based on the amount of movement of the slider b21. In addition, a ratio of a length of the slider b21 to a length of the entirety of the second scroll bar b2 in the direction parallel to the y axis, and a position of the slider b21 with respect to the entirety of the second scroll bar b2 in the direction parallel to the y axis indicate a positional relationship of the items of the second layer, which are currently displayed, with all the items of the second layer displayable in the object region z1. The user can drag the slider b21 by taking into consideration of the positional relationship. Even in a case in which a direct drag operation (drag operation at least including movement in the y direction) is detected, which is not performed on the slider b21 but is performed on the object indicating the item of the second layer, the controller 10 may scroll the objects of the second layer. Also, display modes of the first scroll bar b1 and the second scroll bar b2 may be different from each′ other so as to be easily identified from each other. For example, shapes and/or colors of the sliders b11 and b21 may be different from each other.

The user can recognize the entirety of the items of the second layer by scrolling the items of the second layer in the object region z1 as needed. In addition, the user can perform an operation on any of the items of the second layer as needed. Also, after the controller 10 causes the object of the second layer to be displayed in the object region z1 as illustrated in FIG. 2B, in a case in which an operation of the user is not detected for a predetermined threshold time or more, the controller 10 does not display (terminates displaying of) the second scroll bar b2 as illustrated in FIG. 2C. As a result, the user can recognize contents displayed in a region under the second scroll bar b2. Alternatively, in a case in which a period of time equal to or greater than a threshold elapses after the operation on the second scroll bar b2 is terminated, displaying of the second scroll bar b2 may be terminated. In addition, in a case in which an operation (for example, drag operation) on the object in the object region z1 is detected after the displaying of the second scroll bar b2 is terminated, the controller 10 displays the second scroll bar b2 again.

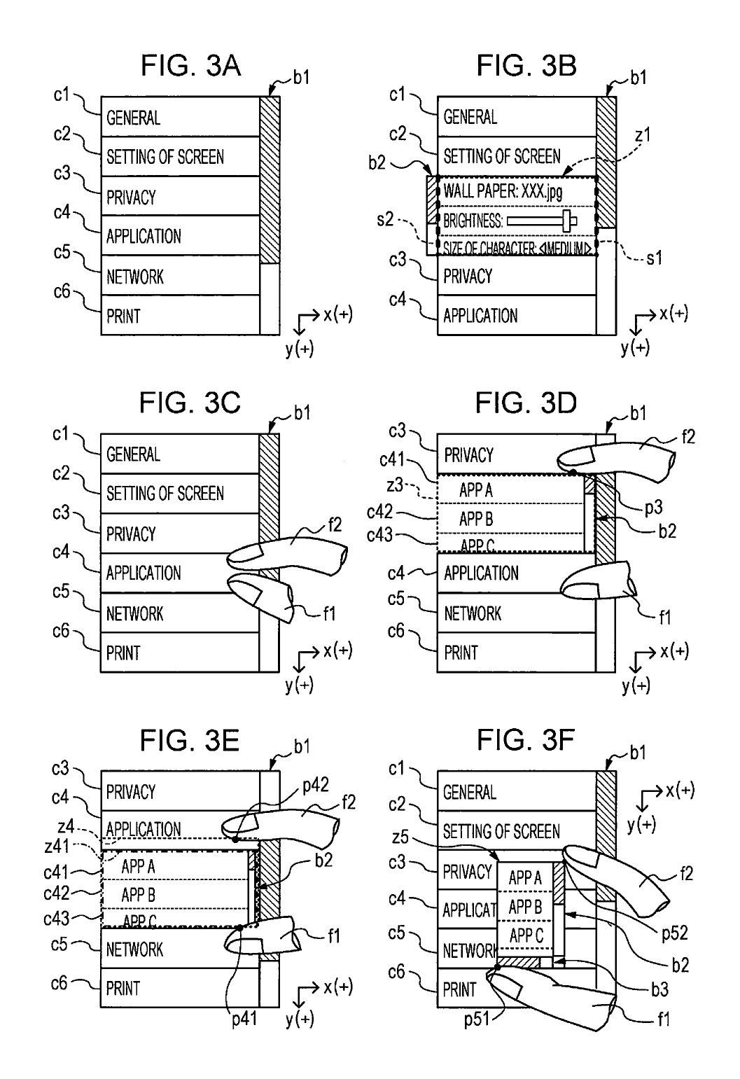

In addition, in a state in which the items of the second layer are displayed as illustrated in FIG. 2C, in a case in which tapping onto the object c2 indicating the item of the first layer relating to the items of the second layer currently being displayed is detected as illustrated in FIG. 2D, the controller 10 terminates displaying of a list of the items of the second layer by canceling the object region z1. The state of the screen is returned to a state before displaying the items of the second layer as illustrated in FIG. 3A by canceling displaying the list of the items of the second layer in the object region z1. Also, in a case in which pinch-in operation is performed after one of the fingers is in contact with the object c2 and the other of the fingers is in contact with the object c3 in a state in which the items of the second layer are displayed as illustrated in FIG. 2B, the controller 10 may terminate displaying of the items of the second layer by closing the object region z1.

In addition, as illustrated in FIG. 2E and FIG. 2F, when the pinch-out operation same as described above performed on the object c2 is detected after the items of the second layer are once displayed, the controller 10 designates an object region again, and displays the items of the second layer in the object region designated again. In a case in which a point p2 (corresponding to position C) after the finger f2 is moved is different from the previous point p1 illustrated in FIG. 2B after the finger f2 is moved, a newly set object region z2 is different from the previous range of the object region z1 illustrated in FIG. 2B. In an example of FIG. 2F, the reset object region z2 is wider than the object region z1 illustrated in FIG. 2B (a length in a direction parallel to the y axis is longer in the reset object region z2 than in the object region z1). The user can easily change the range of the object region by performing the pinch-out operation on the object c2 as many times as the user desires.

Moreover, as illustrated in FIG. 3B, the second scroll bar b2 may be provided on the outside of the object region z1. The first scroll bar b1 in the embodiment is displayed on the outside of the object region z1 along a first side s1 that is one of the two sides of the object region z1 parallel to the y axis. If the second scroll bar b2 is also displayed along the first side s1 on the outside of the object region z1 in a state of being adjacent thereto, the second scroll bar b2 is overlapped with a part of the first scroll bar b1, and is not easily identifiable. Accordingly, when the second scroll bar b2 is provided at a second side s2 opposite the first side s1 as illustrated in FIG. 3B, each of the scroll bars can be easily identified. The second scroll bar b2 may be provided along the second side s2 in the inside of the object region z1.

In addition to the examples described above, various modes can be assumed as the pinch-out operation with respect to the object displaying the item of the first layer and an object region setting method according to the operation. A first example will be described with reference to FIG. 3C and FIG. 3D. After the two fingers f1 and f2 are in contact with the object c4 indicating the item of the first layer, when the controller 10 detects that the finger f2 is moved at least in the y-axis negative direction (hereinafter also referred to as −y direction) while being in contact with the screen and points at a point p3 outside the object c4 illustrated in FIG. 3D and the finger f1 remains while being in contact within the region of the object c4, the controller 10 may set an object region z3 as a region from an end of the object c4 in the −y direction to the point p3.

Next, a second example is described with reference to FIG. 3C and FIG. 3E. After the two fingers f1 and f2 are in contact with the object c4 indicating the item of the first layer, when the controller 10 detects that the finger f2 is moved at least in the −y direction while being in contact with the screen and points at a point p42 as illustrated in FIG. 3E and the finger f1 is moved while being in contact with the screen at least in the +y direction and points at a point p41 as illustrated in FIG. 3E, the controller 10 may move the object c4 following the finger f2 which moves in the −y direction. Further, the controller 10 sets a region from the point p42 to the point p41 (point p42 and point p41 correspond to a position A and a position B, respectively) as an object region z4, and may display objects c41 to c43 indicating items of the second layer in a region z41 which is a part of the object region z4. The region z41 is a region from an end of the object c4 in the +y direction to an end of the object region z4 in the +y direction.

Next, a third example will be described with reference to FIG. 3C and FIG. 3F. In this example, in a case in which the two fingers f1 and f2 perform the pinch-out operation on the object c4, the controller 10 sets, as an object region z5, a rectangular region in which positions p51 and p52 (corresponding to position A and position B) of the fingers after the pinch-out operation are set to diagonal points. The object region z5 set as described above may be displayed to overlap with a group of the objects displaying the items of the first layer as illustrated in FIG. 3F. Alternatively, in order that other objects of the first layer do not overlap with the object region z5, the objects of the first layer before the object c4 are moved in the −y direction and the objects of the first layer after the object c4 may be moved in the +y direction. Also, a third scroll bar b3 corresponding to a scroll in a direction parallel to the x axis of the objects indicating the items of the second layer in the object region z5 may be displayed.

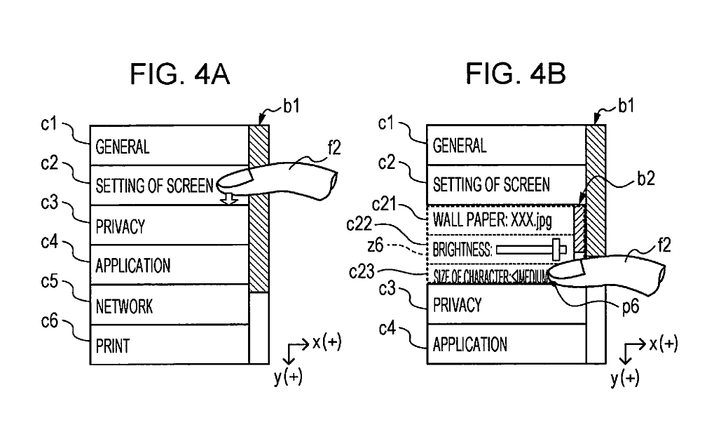

The examples, in which the items of the second layer are displayed in the object region by the pinch-out operation using two fingers, have been described. However, the object region may be set in response to a drag operation using one finger. This example will be described with reference to FIG. 4A and FIG. 4B. For example, in response to pressing and holding performed onto the object c2 by the finger f2, the controller 10 may allow the object c2 to be in an active state. After the state of the object c2 is changed into the active state, when the controller 10 detects that the finger f2 is dragged to a point p6 illustrated in FIG. 4B, the controller 10 may set a region from the object c2 to the point p6 after the dragging of the finger as an object region z6.

### 2. Second Embodiment

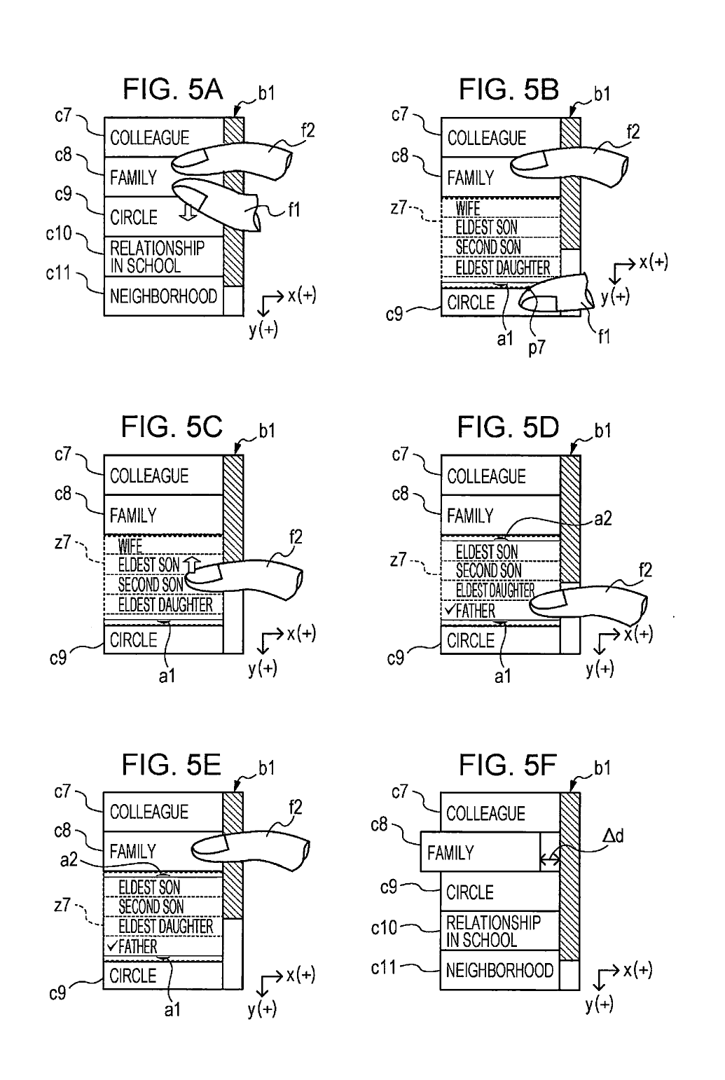

FIGS. 5A to 5F are diagrams for describing an operation and a display control in a second embodiment, and specifically, are diagrams illustrating an operation in which a destination is selected before sending an email and the display control in association with the operation, in a smartphone similar to that of First Embodiment. Destinations are made into groups, for example, a “colleague”, a “family”, a “circle”, a “relationship in school”, and the like. FIG. 5A illustrates objects c7 to c11 indicating a plurality of destination groups which are displayed as a list. In a state illustrated in FIG. 5A, for example, when the controller 10 detects the pinch-out operation performed by the two fingers f1 and f2 on the object c8 indicating a group of the “family”, the controller 10 displays a list of destinations included in the “family” group in an object region z7 which is a region from the object c8 to a point p7 indicated by the finger f1 after the pinch-out operation as illustrated in FIG. 5B.

In a case in which the entirety of the destinations included in the “family” is not allowed to be displayed in the object region z7 simultaneously, the controller 10 displays in the second embodiment an arrow mark instead of a scroll bar in at least one end portion of the object region z7 in a direction where the objects indicating the destinations are arranged (direction parallel to y axis). An arrow mark a1 indicating the +y direction illustrated in FIG. 5B indicates that another destination continuing to the “eldest daughter” exists. As illustrated in FIG. 5C, when a drag operation is performed on the object region z7 in the −y direction, the controller 10 displays “father” continuing to the “eldest daughter”, which has not been displayed, by scrolling the destinations in the object region z7 as illustrated in FIG. 5D, and sets “wife” which has been displayed as a display subject not to be displayed (non-display). In addition, the controller 10 causes an arrow mark a2 to be displayed. The arrow mark a2 points in the −y direction and indicates that there is a destination not displayed but existing before the “eldest son”. Each of the arrow marks a1 and a2 corresponds to “the object indicating that the second object not being displayed exists”. The object is not limited to an arrow mark as long as the object is capable of indicating that the second object not being displayed exists.

As described above, when the arrow mark is displayed instead of the scroll bar, the user can recognize that the destination, which is not displayed currently, exists in the object region z7. The user can display the destination, which is not displayed currently, by scrolling the destinations in the object region z7 with reference to the arrow mark.

In addition, when the controller 10 detects that the user taps a region indicating any destination included in the “family” to select the destination (FIG. 5D illustrates that the “father” is selected), and taps (corresponding to first operation) the object c8 as illustrated in FIG. 5E, the controller 10 cancels the object region z7 and terminates displaying the destinations which are displayed in the object region z7. In response to cancellation of the object region z7, the controller 10 returns and displays the objects c9 to c11 continuing to the object c8 as illustrated in FIG. 5F at positions before setting the object region z7.

Regarding the object c8, the object region z7 is closed in a state in which the “father” included in the group of the “family” has been selected. Therefore, in the embodiment, in order to indicate that the destination selected in the group of the “family” exists, a display position of the object c8 is changed as compared to a case in which a destination selected in the group of the “family” does not exist. Specifically, the controller 10 causes the object c8 to be displaced in the x-axis negative direction (hereinafter also referred to as −x direction) and displayed as illustrated in FIG. 5F. That is, the object c8 is displayed by being displaced in a direction orthogonal to a direction where the objects c7 to c11 including the object c8 as the first object are arranged in a row. As a result, the user can easily recognize that a destination included in the group of the “family” is already selected, even after closing the object region z7.

A movement amount (Δd) of the object c8 in the −x direction may be changed in accordance with the number of selected destinations. For example, as the number of destinations selected increases, the movement amount Δd may be increased. As a result, a degree of the number of the already selected destinations can be intuitionally recognized.

### 3. Third Embodiment

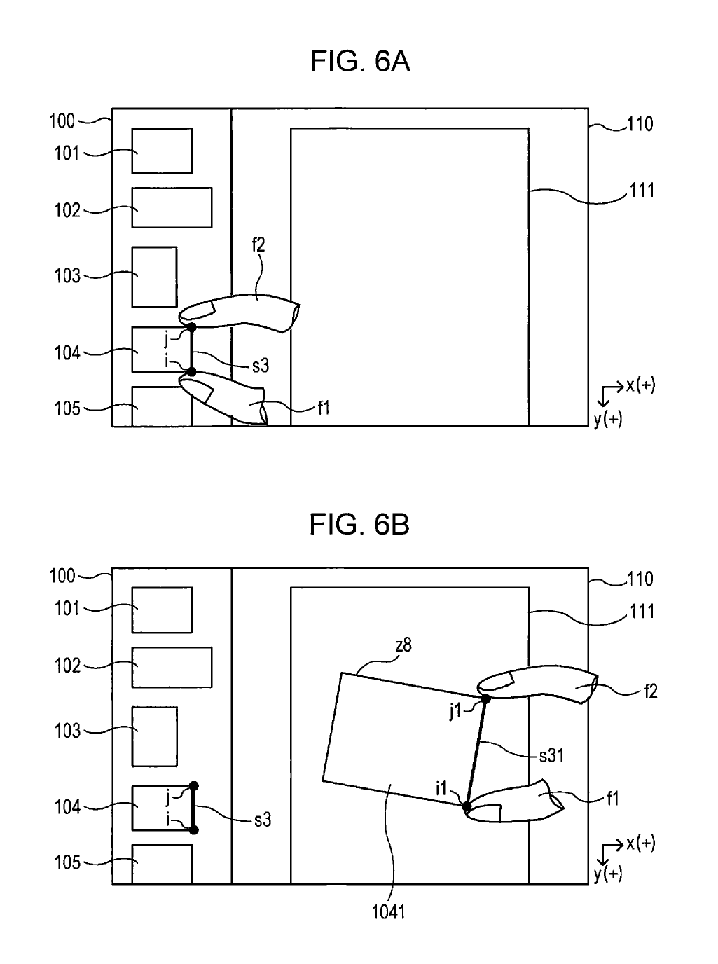

FIGS. 6A and 6B are diagrams for describing an operation and a display control in a third embodiment, and specifically, are diagrams illustrating an operation for arranging an image at the time of preparing documents and a display control in association with the operation in a tablet terminal having a configuration similar to that of FIG. 1. In a region 100 illustrated in FIG. 6A and FIG. 6B, a plurality of images 101 to 105 that are candidates to be disposed are arranged and displayed. A region 111 of a working region 110 corresponds to one page of a document to be prepared.

In this embodiment, when two fingers touch a candidate image to be disposed and drag the image while performing a pinch-in or pinch-out operation, the image to be disposed can be moved and disposed while being reduced or enlarged in size. A specific example will be described in detail. Apexes i and j of an image 104 displayed in the region 100 are points of both ends of a right side s3 of the image 104. When the controller detects that the fingers f1 and f2 respectively touch the apexes i and j and drag the apexes into a region 111 of the working region 110 while performing the pinch-out operation using the fingers f1 and f2, the controller 10 calculates the distance between a point j1 pointed by the finger f2 after being moved and a point i1 pointed by the finger f1 after being moved. The controller 10 calculates a ratio between the calculated distance and the length of the right side s3 of the image 104. The controller 10 enlarges the image 104 based on the calculated ratio and displays a generated image 1041 so that both ends of the right side s31 of the generated image 1041 overlap with the points j1 and i1.

In this embodiment, the image 104 corresponds to the first object, and the image 1041 corresponds to the second object. In addition, the region displaying the image 1041 corresponds to an object region z8. The point j1 and the point i1 respectively correspond to the position A and the position B. The finger f1 and the finger f2 respectively correspond to a first instruction tool and a second instruction tool. As described above, according to this embodiment, the user can designate as desired the position where the image 104 is disposed and the size of the image 104 by one pinch-out operation using the two fingers f1 and f2. In addition, the user can also designate whether the image 104 is rotated or not, along with the designation of the position and the size thereof. As a matter of course, the user can perform a reduction of the image, disposing of the image at any position, and rotation thereof by dragging while performing the pinch-in operation.

Moreover, of course, in a case in which the finger f1 or the finger f2 is moved to the outside of a region (for example, the working region 110 in this embodiment) in which an image or the like is able to be displayed, the fingers f1 and f2 are considered as pointing at the inside of the region, and an object region to be actually set is set to be smaller than a region defined by the positions of the fingers f1 and f2 after moved. That is, the finger may point at a position different from a position at which the finger actually points. Instead of the both end points i and j on the right side s3 of the image 104, for example, diagonal points of the image 104 may be points to be operated, or any points in the image 104 may be the points to be operated. For example, in a case in which diagonal points are the points to be operated, it may be possible to change an aspect ratio in addition to enlarging/reducing the size of the image, disposing the image at a desired location, and rotating the image.

### 4. Other Embodiments

A technical range of the invention is not limited to the above described examples, and of course, is variously modified within a range not deviated from a gist of the invention.

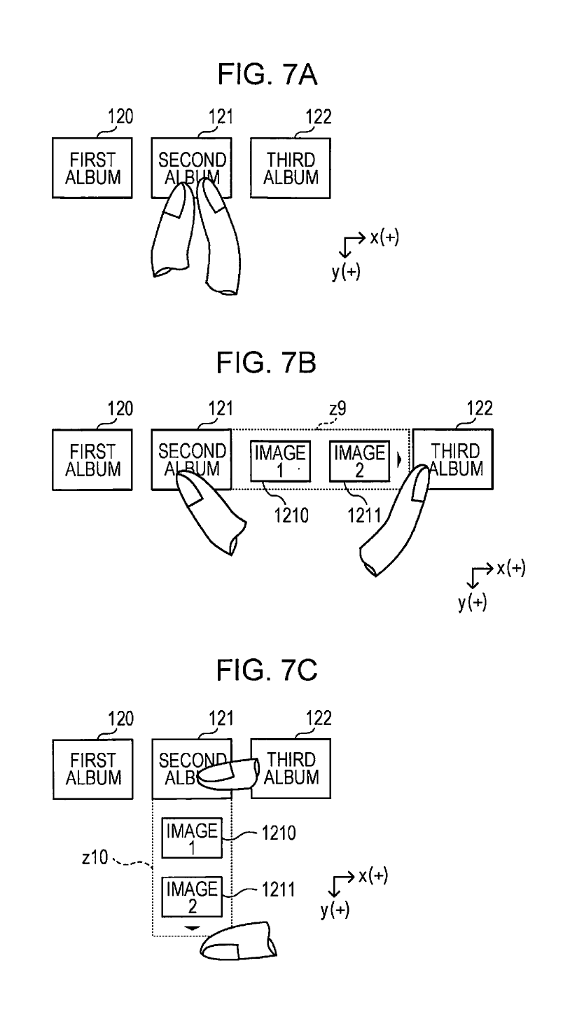

FIG. 7A and FIG. 7B illustrate an example in which objects 120 to 122 indicating a plurality of albums are arranged side by side parallel to the x axis and when the user performs a pinch-out operation, in which fingers are moved at least in a direction parallel to the x axis so as to increase the distance between the fingers, on the object 121 indicating the second album among the albums, images 1210 and 1211 included in the second album are displayed in an object region z9. In this case, the object 121 corresponds to the first object, and the images 1210 and 1211 correspond to the second objects. As described in this example, the objects 120 to 122 including the object 121 as the first object may be arranged side by side in a direction parallel to the x axis, and also the second objects in the object region z9 may be arranged side by side in a direction parallel to the x axis and displayed. The arrangement of the second objects in the object region z9 is not limited to a mode in which the second objects are arranged in the direction parallel to the direction in which the objects 120 to 122 are arranged side by side. For example, as illustrated in FIG. 7C, the user may perform the pinch-out operation so that the distance between the fingers increases in a direction orthogonal to the direction where the objects 120 to 122 are arranged side by side. In an object region z10 set by such pinch-out operation, the objects 1210 and 1211 as the second objects may be arranged and displayed side by side in a direction orthogonal to the direction in which the objects 120 to 122 are arranged side by side. In addition, in the object region set by the pinch-out operation, the second objects may be two-dimensionally arranged in longitudinal and lateral directions.

The electronic device is not limited to a smartphone, and may be a personal computer which causes a separately provided display to display an image or the like, a multifunction machine which performs printing and FAX communication, a device such as a projector which performs display by projecting a subject on a screen, or the like. The electronic device may be a computer which does not include a touch panel, and instruction tools in this case may be a mouse, direction keys and determination keys, fingers or a touch pen to be used for a touch pad (track pad), for example. In addition, the instruction tool may be a tool such as a mouse pointing at one position, or tools such as two or three fingers pointing at two or more positions. For example, when four fingers are used, an object region may be set by pointing at four corners of the object region using the four fingers.

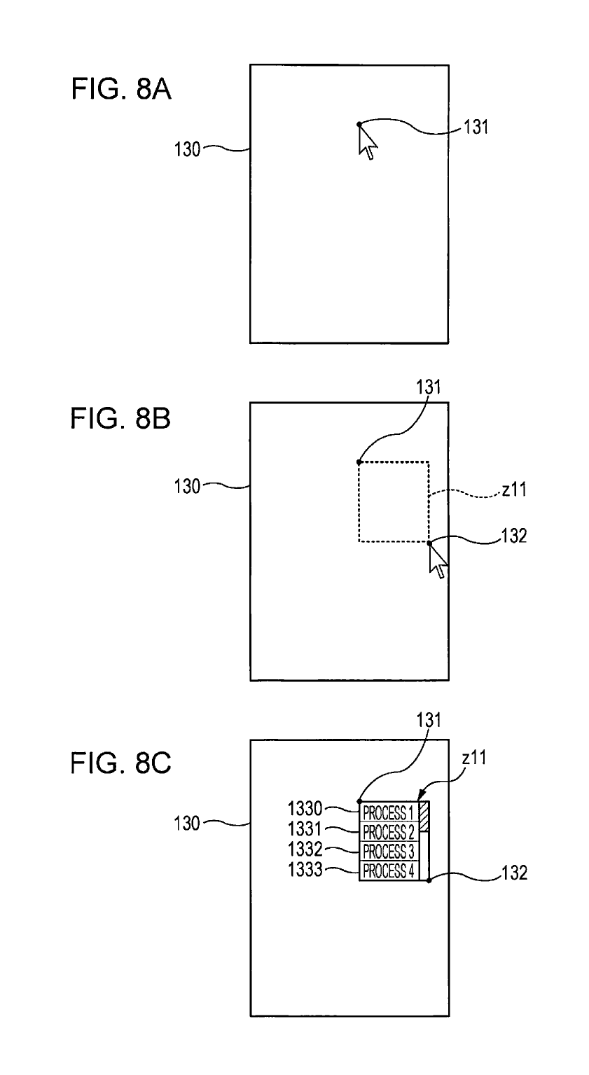

In the embodiments described above, examples in which an object region is set outside of the first object, are described, however, the object region may be set in the first object as illustrated in FIGS. 8A to 8C. FIGS. 8A to 8C illustrate an example in which a region from a point 131 to a point 132 which are any positions designated by the user in an image 130 (rectangular region in which the point 131 and the point 132 set as diagonal points) is set as an object region z11, and candidates for image processes to be performed on the image 130 are displayed as a list in the object region z11 (attribute information of the image 130, or the like may be displayed). Specifically, for example, when the user clicks a right button of a mouse in a state in which a mouse cursor points at the point 131 as illustrated in FIG. 8A and drags the cursor to the point 132 while clicking the right button of the mouse as illustrated in FIG. 8B, a list of image processes is displayed as illustrated in FIG. 8C. In this example, the image 130 corresponds to the first object and objects 1330 to 1333 indicating the image processes correspond to the second objects. A scroll button (scroll arrow) may be provided in an end portion of the scroll bar.

What is claimed is:

1. An electronic device comprising:
a display controller that causes a display section to display an image; and
a detecting section that detects movement of an instruction tool,
wherein in response to the instruction tool pointing at a first object and pointing at a different position A in a state in which the display section displays the first object, the display controller causes a second object relating to the first object to be displayed in an object region which is a region having the position A as an end of the region.

2. The electronic device according to claim 1,
wherein the first object indicates a content group, and the second object indicates contents included in the content group.

3. The electronic device according to claim 1,
wherein the object region is a region extending from a region indicating the first object before the second object is displayed to the position A.

4. The electronic device according to claim 1,
wherein the object region is a region extending from the position A pointed by a first instruction tool to a position B pointed by a second instruction tool.

5. The electronic device according to claim 1,
wherein the display controller causes a first scroll bar corresponding to the first object to be displayed outside the object region, and causes a second scroll bar corresponding to the second object to be displayed in the object region.

6. The electronic device according to claim 1,
wherein the display controller causes a first scroll bar corresponding to the first object to be displayed outside an object region in rectangular shape along a first side of the object region, and causes a second scroll bar corresponding to the second object to be displayed outside the object region along a second side opposite the first side of the object region.

7. The electronic device according to claim 5,
wherein the display controller causes displaying of the second scroll bar to be terminated, in a case in which a movement of the instruction tool is not detected for a period of time that is equal to or greater than a threshold after the second object is displayed in the object region.

8. The electronic device according to claim 1,
wherein the display controller causes a first scroll bar corresponding to the first object to be displayed outside the object region, and causes another object which indicates that the second object currently not displayed exists to be displayed in at least an end portion in a scroll direction of the second object in the object region.

9. The electronic device according to claim 1,
wherein the display controller causes the first object to be displayed, even when the second object is displayed in the object region, and the display controller causes displaying of the second object to be terminated by canceling the object region in response to the instruction tool again pointing at the first object.

10. The electronic device according to claim 1,
wherein the display controller causes the first object to be displayed, even when the second object is displayed in the object region, and causes the object region to move to a region, in which a different position C is set as an end in response to the instruction tool pointing at the position C after pointing at the first object again during the second object being displayed in the object region.

11. The electronic device according to claim 1,
wherein, in a state in which a plurality of second objects are displayed in the object region, the display controller terminates displaying of the plurality of the second objects by canceling the object region in response to detecting of a first operation of a user, and
wherein the display controller causes the first object, in a case in which the second objects are not displayed but at least one of the second objects has been selected, to be displayed at a position different from a position in a case in which any one of the second objects has not been selected.

12. A non-transitory computer-readable medium storing a control program which causes a computer to realize:
a display controlling function of causing a display section to display an image; and
a detecting function of detecting a movement of an instruction tool,
wherein the display controlling function includes a function of, in response to the instruction tool pointing at a first object and pointing at a different position A in a state in which the display section displays the first object, causing a second object relating to the first object to be displayed in an object region which is a region having the position A as an end of the region.
